(19) United States
(12) Patent Application Publication
(10) Pub. No.: US 2014/0164210 A1
(43) Pub. Date: Jun. 12, 2014

(54) Method and System for Structured Settlement Auctions and Trading

(71) Applicants: Benjamin Geber, Vienna, VA (US); Michael Worch, Gaithersburg, MD (US)

(72) Inventors: Benjamin Geber, Vienna, VA (US); Michael Worch, Gaithersburg, MD (US)

(21) Appl. No.: 14/103,812

(22) Filed: Dec. 11, 2013

Related U.S. Application Data
(60) Provisional application No. 61/735,997, filed on Dec. 11, 2012.

(51) Int. Cl. G06Q 40/04

(52) U.S. Cl. CPC G06Q 40/04
USPC 705/37

(57) ABSTRACT

The methods and systems are provided that provide an efficient, transparent and automated auction and trading exchange for structured settlements and other structured cash flows. The automated auction and trading system automatically determines and processes structured settlement and cash flow sales between buyers and sellers. The system may process the entire transaction automatically and electronically, including document processing and receipt and transmission of funds.

### RELATED APPLICATIONS

This application claims priority to U.S. Provisional Patent Application No. 61/735,997 filed Dec. 11, 2012, which is hereby incorporated by reference herein.

### FIELD OF THE INVENTION

The present invention generally relates structured settlements and other structured cash flows, and more particularly to an automated system for auctioning and trading structured settlements and other structured cash flows.

### BACKGROUND

The structured cash flow market brings together a seller who for any number of reasons is receiving cash flows at regular or irregular intervals for a term of years or a lifetime, or is expected to receive cash flows for a term or a lifetime, and would rather sell those cash flows in exchange for a lump sum payment at a discount from a buyer. For example, in a structured settlement transaction (one of the many types of structured cash flows that may be available for trade on the auction website), a plaintiff who is injured in an automobile accident, may obtain a court judgment in his or her favor which pays $5,000 per month for 20 years guaranteed. This payment is usually made by a commercial life insurance company. The plaintiff may decide either initially or at some later date, that they have a need for a lump sum of money today, in exchange for all or a portion of their $5,000 per month, so they sell the cash flow they choose to a retail or institutional buyer, usually through a combination of originators, financial advisors or other financial middle people or brokers who structure and facilitate the transaction. In the case of the described structured settlement, there is a court ordered process in which a judge must approve the transaction after which there is an irrevocable assignment of the cash flow to the new assignee in exchange for the lump sum payment that has been contractually agreed upon. Conventionally, these transactions take place and involve one to five or more middle people.

Finding the opportunity to purchase the cash flow of a seller is done most often through email listings or website postings where a buyer or financial middle person must look through many transactions, usually from limited sources, who have pre-priced the cash flows based on their limited inventory and limited sales channels. On the other side of the transaction, the seller of the cash flow usually answers any variety of advertisements from various sources such as the Web, paper, radio or TV, who make an offer to buy seller's cash flow. While the seller can call and shop around for the best purchase price, they may never really know if they have received the proper value for their cash flow. This inefficient market on both ends of the transaction, causes a lot of potential profits in which the buyer and seller should be the ultimate benefactors of the transaction to lose money to various brokers, attorneys and other financial middleman. Examples of structured cash flows that are currently traded include but are not limited to structured settlements, judgment on appeals settlements, pension cash flows, annuities, estate settlements, pre-funded attorney fees, pre-funded court settlements, life settlements, etc. Current buyers and sellers for these transactions include but are not limited to banks, insurance companies, individuals, hedge funds, family offices, or any other suitable entity.

The conventional secondary market for structured settlements typically begins with an existing settlement holder in need of a lump sum of cash or whose interest is peaked through the marketing efforts of originators. These include, but are not limited to companies such as JG Wentworth, Stonestreet, Imperial, Novation, Patriot, 123 Lump Sum, Catalina Funding, Seneca One, Access Funding and dozens more. Current marketing is done through television, internet, court scrapes, lists of structured settlement holders who have previously sold part of their settlement etc. This is a competitive industry and conventionally with supply significantly less than demand, and typically limited capacity on the sell side, originators may aggressively try to motivate sellers to choose them to assist in the legal process to transfer their cash flow(s). Sellers may or may not know how competitive the market is and how many originators will compete for their business if given the opportunity, so they may or may not be getting the best price for their cash flow. While regulations increase transparency to a seller about their transaction after they have contracted, a seller may never know if they received the most competitive offer for their cash flow.

As such, there is a need for yield and liquidity, and the structured cash flow market has allowed for billions of dollars to trade hands when there is a buyer needing yield and a seller needing liquidity. As a multibillion dollar market, there is a great need for a more efficient, rapid and transparency structured cash flow market.

### SUMMARY

In accordance with the present invention, a method in a data processing system for auctioning and trading structured settlements is provided, comprising receiving information from a buyer on a structured settlement to be sold, and receiving a bid from a buyer to buy the structured settlement. The method further comprises determining if the bid is the highest bid for the structured settlement, and automatically processing the receipt of funds from the buyer if the bid is the highest bid. Additionally, the method comprises automatically providing the received funds to the seller.

### BRIEF DESCRIPTION OF THE DRAWINGS

FIG. 1 illustrates an exemplary computer system consistent with systems and methods consistent with the present invention.

FIG. 2 shows an exemplary computer network such as the Internet having a web server for a website and computers used by various potential participants.

FIG. 3 illustrates an overview of a system and processes for automated structured settlement auctioning and trading.

FIG. 4 depicts an exemplary settlement listing webpage.

FIG. 5 illustrates an exemplary settlement listing comparison webpage.

FIG. 6 shows a flowchart having steps of a method consistent with the present invention.

### DETAILED DESCRIPTION

Methods and systems in accordance with the present invention address this need by providing an efficient, transparent and automated marketplace, in the form of an online auction or trading platform, for structured settlements and other structured cash flow transactions. An automated auction and trading system is provided for automatically selling structured settlements and cash flows between buyers and sellers. Instead of relying on originators and other financial middle people, and limited options for sellers and buyers, the market established by these systems creates an efficient process in which buyers and sellers alike can access more important information to better determine the true value of the cash flow being bought and sold, as well as a significant increase in the number of buyers who can view many more cash flows and sellers who can receive offers from many more potential buyers. Most transactions conventionally take place in a captive environment where sellers only get a few offers and buyers only have access to a small percentage of cash flows that are available for purchase. The process and transparency leads to a more efficient market where the buyer and seller are the ultimate benefactors. The system has the information for the parties to properly evaluate a transaction. Identifying information may be redacted until the proper time for disclosure.

In one implementation, the system is marketed to structured settlement holders, but different from originators, helps the seller determine which cash flows make the most sense to sell and once determined, those cash flows will be listed for the originators to bid on in a live online auction format. Originators bid the rate down which increases the amount of money a seller will receive. The secondary market for structured cash flows has received bad press in the past as some feel that sellers of structured settlements are being taken advantage of. If a seller is in need and in some cases, desperate need, of cash, they may receive and accept a much higher discount rate and thus less money than they would through a competitive bid process. The structured settlement holder likely does not know that offers can differ by thousands, if not tens or hundreds of thousands of dollars.

In one embodiment, the system posts the seller's cash flow on the electronic live auction with a minimum initial offer price. The originators are able to bid up until the end of the auction at which time the highest purchase price and thus lowest discount rate will be the winner. The system may electronically facilitate the documentation between the structured settlement holder and the originator. In one implementation, the system electronically facilitates all documents for closing the transaction. This will allow for a systemized process for every transaction where process can be managed and monitored. Alternatively, the structured settlement holder and the originator may transact the contracts offline. In another implementation, the system facilitates all collection and distribution of money automatically.

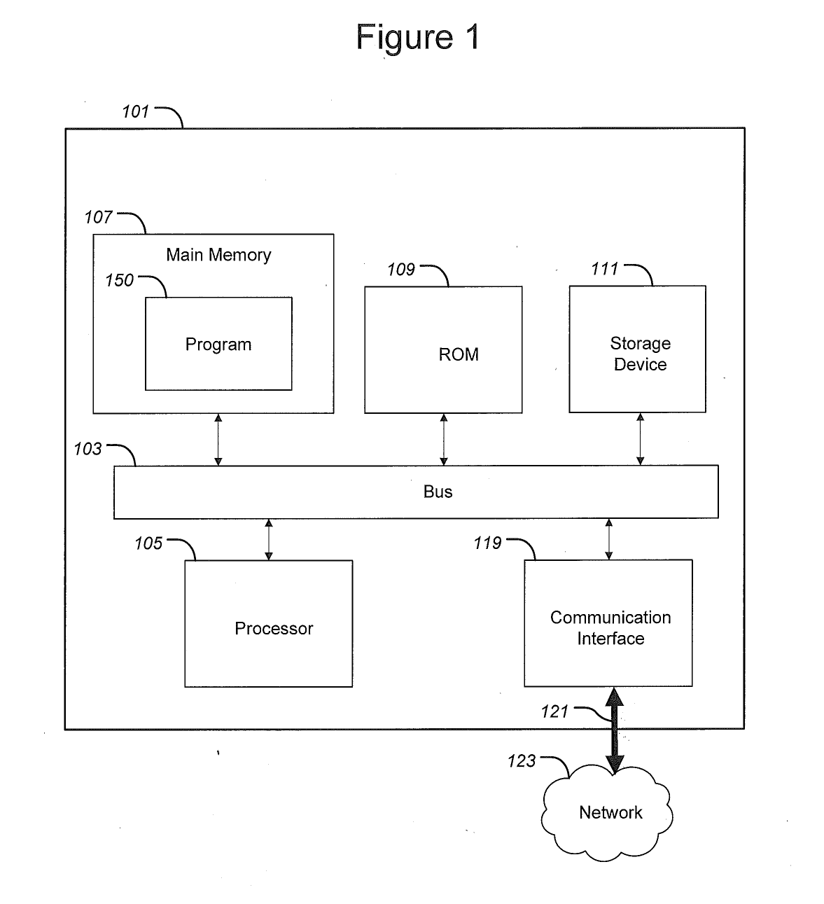

FIG. 1 illustrates an exemplary computer system 101 consistent with systems and methods consistent with the present invention. Computer 101 includes a bus 103 or other communication mechanism for communicating information, and a processor 105 coupled with bus 103 for processing the information. Computer 101 also includes a main memory 107, such as a random access memory (RAM) or other dynamic storage device, coupled to bus 103 for storing information and instructions to be executed by processor 105. In addition, main memory 107 may be used for storing temporary variables or other intermediate information during execution of instructions to be executed by processor 105. Main memory 107 includes a program 150 for implementing a structured settlement auction and/or trading consistent with methods and systems consistent with the present invention. Computer 101 further includes a read only memory (ROM) 109 or other static storage device coupled to bus 103 for storing static information and instructions for processor 105. A storage device 111, such as a magnetic disk or optical disk, is provided and coupled to bus 103 for storing information and instructions. Computer 101 may be Auction Exchange Server 10 as described above.

According to one embodiment, processor 105 executes one or more sequences of one or more instructions contained in main memory 107. Such instructions may be read into main memory 107 from another computer-readable medium, such as storage device 111. Execution of the sequences of instructions in main memory 107 causes processor 105 to perform the process steps described herein. One or more processors in a multi-processing arrangement may also be employed to execute the sequences of instructions contained in main memory 107. In alternative embodiments, hard-wired circuitry may be used in place of or in combination with software instructions. Thus, embodiments are not limited to any specific combination of hardware circuitry and software.

Although described relative to main memory 107 and storage device 111, instructions and other aspects of methods and systems consistent with the present invention may reside on another computer-readable medium, such as a floppy disk, a flexible disk, hard disk, flash drive, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

Computer 101 also includes a communication interface 119 coupled to bus 103. Communication interface 119 provides a two-way data communication coupling to a network link 121 that is connected to a network 123, such as the Internet or other computer network. Wireless links may also be implemented. In any such implementation, communication interface 119 sends and receives signals that carry digital data streams representing various types of information.

In one implementation, computer 101 may operate as a web server on a computer network 123 such as the Internet. Computer 101 may also represent other computers on the Internet, such as users' computers having web browsers, and the user's computers may have similar components as computer 101.

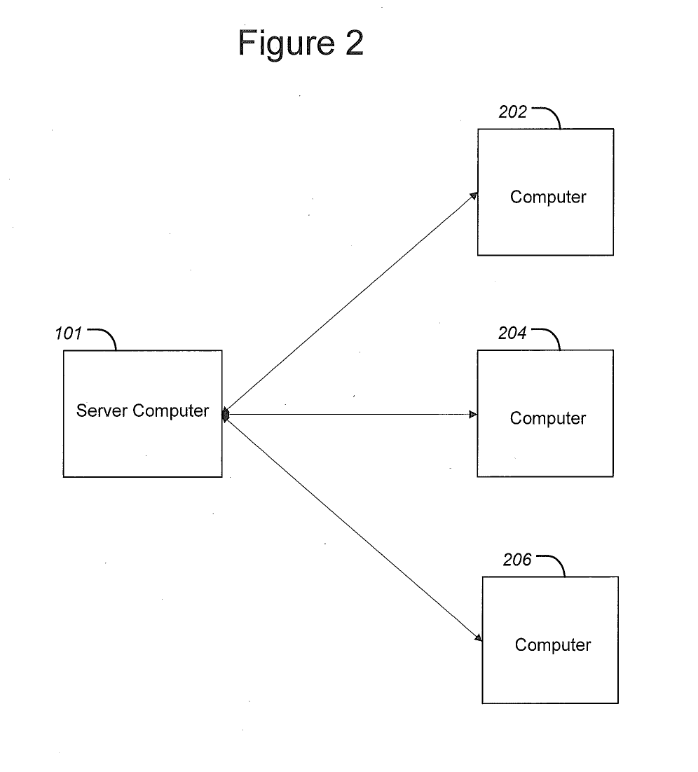

FIG. 2 shows an exemplary computer network such as the Internet having a web server for a website and computers used by various potential participants. As described above, computer 101 may be a server having the components described above and may implement methods and systems consistent with the present invention. Computers 202-206 may include web browsers and may be used by users to access the Internet or other network and access computer server 101. There may be any number of user computers and any number of server computers. Users of computers 202-206, for example, may be buyers and sellers on the auction or trading system by accessing the website server 101. These computers may be operated by these participants.

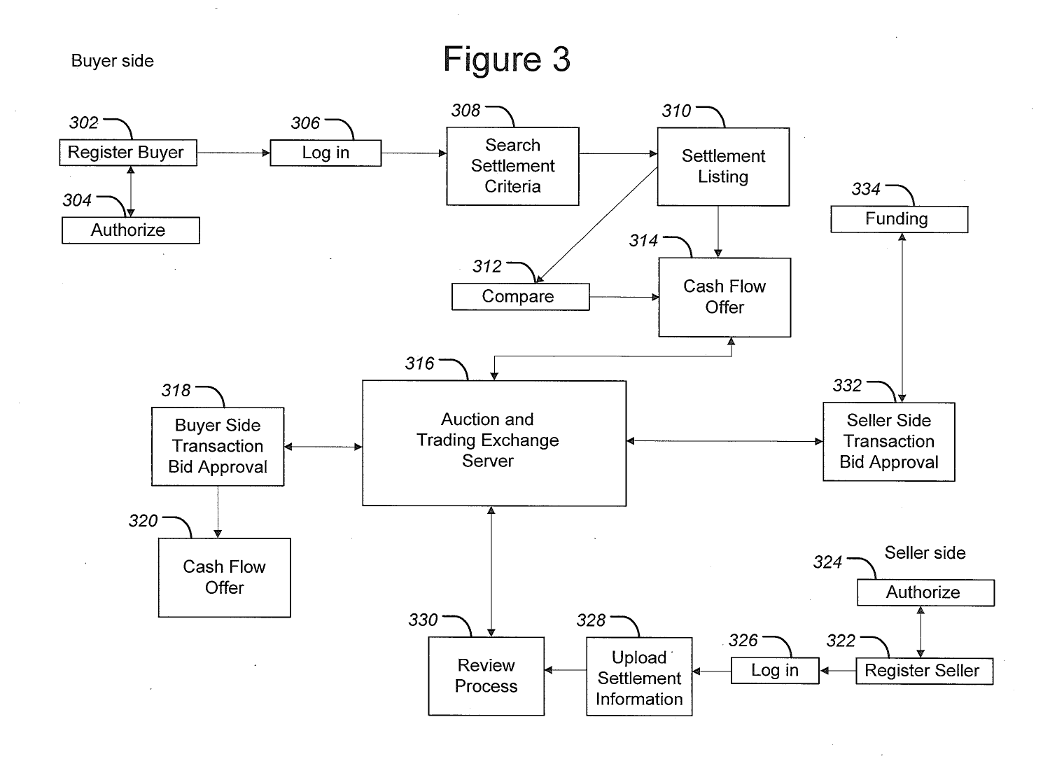

FIG. 3 illustrates an overview of a system and processes for an automated structured settlement auction. First, a buyer registers by accessing a website page 302, for example. This page may provide a register page 304 and a login page 306 (discussed below). Clients log onto the website and click the register Button. Here, they enter information on name, company, email and phone and any other relevant information. At this time, they may register as a Financial Advisor, Broker Dealer, Registered Investment Advisor, Investment Advisor Representative, charity, church, pension fund, life insurance company, family office, or individual, for example. Once the Registration information is entered, the buyer's registration may then be authorized 304. The buyer may be filtered through pre-determined criteria to make sure they are qualified to view or purchase. For example, they may be checked to ensure they meet a status such as Financial Advisor, etc. The website may send an email to a person who reviews the Registration and provides a log in code. The authorization process may be automated or manual. Alternatively, this registration and login code return may be automated.

Next, the buyer logs in 306 with a log in code which allows him to search the website. A buyer may be first shown the settlement search criteria webpage 308. Here, a buyer may search minimum amounts, maximum settlement price, rate, length of auction, date range, payout schedule, minimum and maximum discount rate, cash flow amount, installment terms, deferred payout, immediate payout or deferred with installment payout rating of insurance company offering, etc. Any other suitable search criteria may be used. They can also search all available structured cash flows, e.g., structured settlements, as well.

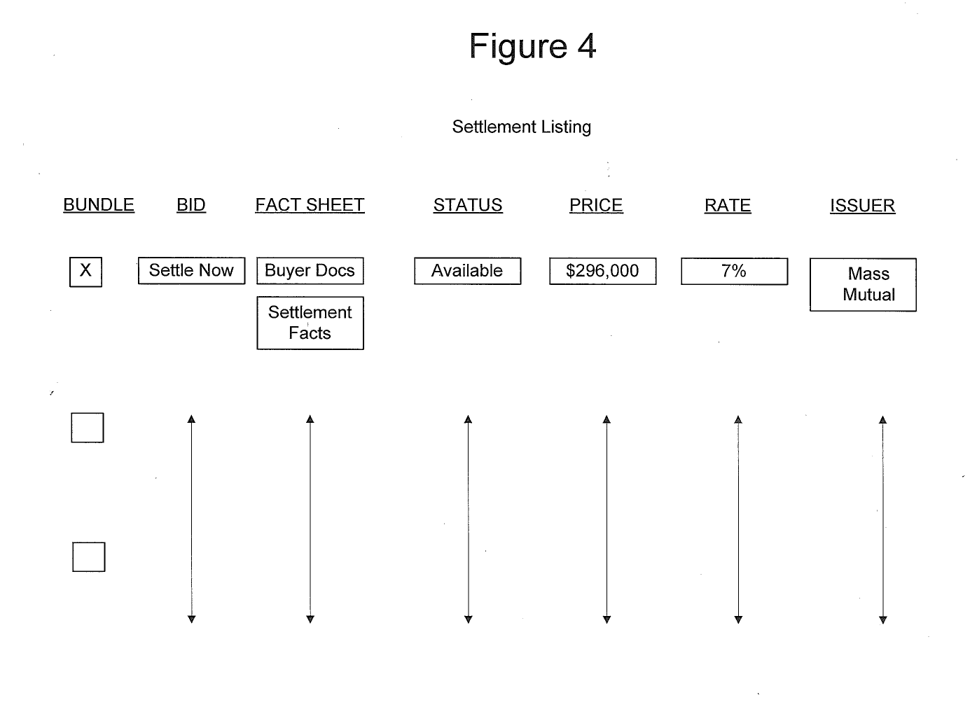

FIG. 4 depicts an exemplary settlement listing webpage 310. This is a page where a buyer looks at the listings they searched for or all listings. It may have the information the buyer needs to make a purchase. They may see if the cash flow is available now to purchase or bid. They may access the opening bid, bid price or Settle Now button. The settle now button gives the buyer the opportunity to end the auction immediately at the price indicated. They may also view related court documents. They can view the cash flow and amortization schedules (not shown), discount rate/yield, insurer (e.g., Mass Mutual), or any other relevant information. They may also have the ability to purchase multiple settlements at once, and search for and purchase a number of different settlements to create their own portfolio of settlements. They may Bundle Now or Aggregate Now (not shown), for example. With Bundle Now, a buyer will choose the cash flows one by one for purchase, and may choose more than one to combine. The Aggregate Now allows the buyer to select the criteria they want such as term, length of auction, rate, cash flow, deferred payout, immediate payout, deferred installment payout and lump sum purchase price, minimum insurance company rating (if applicable) and the system will provide the settlements that fit the criteria. Other suitable search options may also be performed.

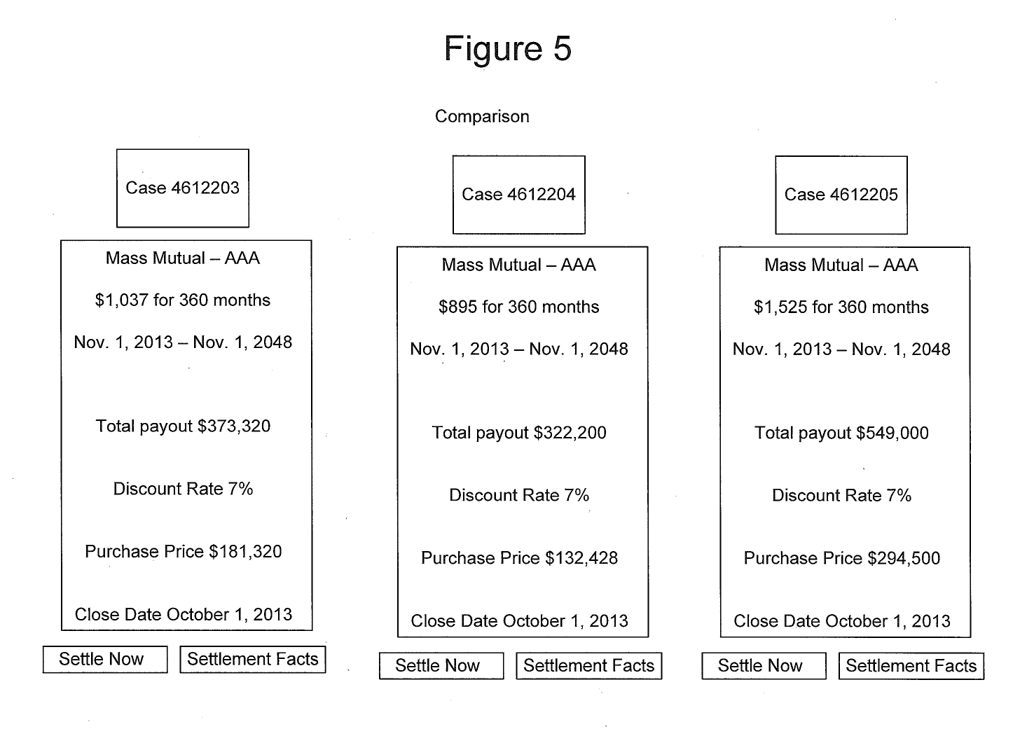

FIG. 5 displays an exemplary settlement listing comparison webpage 312. Here, the buyer compares different settlements and decides which to choose based on the viewing ability of side by side comparison and amortization schedules, discount rates, issuing company, ratings, purchase price, payout start date, payout end date, length, installment schedule, total payout, etc. The buyer may select the settlement listings to compare from the settlement listings page 310.

Next, a buyer may view a cash flow offer website page 314. It may show a minimum bid amount. If a buyer is interested, they may select to make an offer. In one implementation, this page is dedicated to the sole bid or purchase of a settlement. Here, a buyer will enter a Bid or Settle Now price in the make offer box. This sends the offer to the auction and trading exchange server 316 and returns feedback confirming the offer, and notifies the buyer if and when the offer is accepted or if there is a counter offer.

The auction and trading exchange server 316 calculates offers and bids between puts the buyers and sellers and determines a winning bid or offer for the offers. This is an automated auction server 316 to accept and manage the bids and listings and to automatically determine the winning bidders/buyers of each auction. This server may also display the listings, handle settlement searches, comparisons, offers and various other functions described herein. The auction exchange server 316 may be a computer system such as computer 101 described above.

Upon acceptance of a bidder, the parties receive directions and documents to sign from the system. Documents are signed electronically or as required per transaction. Upon approval of a bid on the buyer's side 318, a down payment, e.g., 10%, may optionally be automatically withdrawn from the buyer's account to hold the transaction. This transaction bid approval may be applicable to each auction that closes with a winning bidder. The down payment may be automated online on the website via credit card, electronic funding or any other suitable method, potentially in conjunction with an escrow agent. Alternatively, a third party may administer the escrow services off the website.

Upon closing, the buyer is to receive the purchased cash flow 320. Closing documents may be electronically delivered to the parties and funds exchanged. Alternatively, closing documents may be mailed to the parties. In one implementation, the system automatically facilitates the entire transaction electronically.

To put cash flows on the auction or trading system, on the seller side, the seller registers on the website on the sellers' register page 322. Sellers, such as originators of cash flows who represent and work directly with the original assignees of the cash flow, register on this page. In one implementation, an e-mail is sent through the server for the approval of their registration. The system checks pre-determined criteria to make sure they are qualified to sell. The authorization process 324 may be automated or manual. Once approved, a confirmation e-mail may be sent. Original assignees also have the ability to register directly to auction their cash flow. Sellers, whether individual or institutional, are validated and approved. Once approved, the seller of the cash flow may log in 326 to enter the system.

After logging in, a seller may upload information on their cash flow for sale and settlement criteria on a webpage 328 that displays the listing of cash flows by a seller. The seller uploads new cash flows for sale to the auction or modifies their current auctions. They may enter the details of the cash flow including, for example, dollar amounts, term, dates of payout, and maximum discount rate they will sell at and the corresponding sale price. They may also list their Settle Now discount rate and corresponding sale price if they choose to use this option, and insurance company information if a structured settlement. They may also input their minimum bid. Cash flows may be entered into the program by sellers which will be interactive and allow buyers to adjust the discount rates to determine what their bids will be. The seller may upload court documents with personal information redacted at this point.

Then the auction system check performs a review process 330 and quality check to assure cash flow marketability and that appropriate documents have been uploaded to be put on the auction exchange server 316. The auction and trading server 316 determines that winning bidder.

Once a winning bid has been approved, the system supplies the seller's closing documents to the buyer 322. At the funding stage, the system automatically collects the purchase price from the buyer and provides it to the seller. Alternatively, the seller collects the purchase price from the buyer via escrow account, for example. Other funding options are possible.

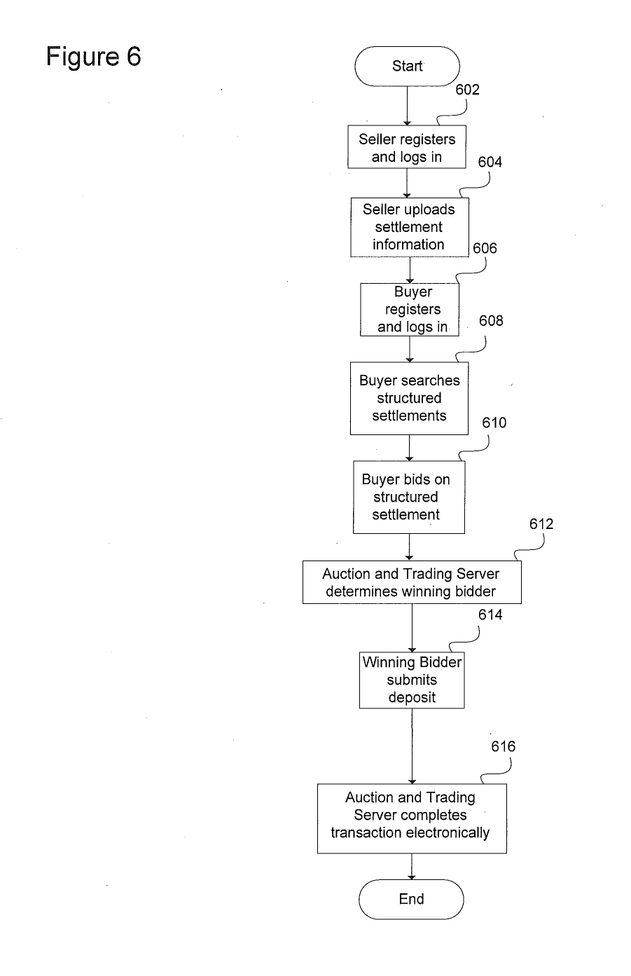

FIG. 6 shows steps in an exemplary method for an auction and trading system for structured settlements. On the electronic platform for buying and selling structured settlements and other structured cash flows, the following is an example of a structured settlement transaction. Sellers (current assignees of a structured settlement stream of payments, or originators working with the sellers for example) register 322 and log into the auction and trading system (step 602). This may be done through a password-protected login 326 on the seller side of the exchange. The seller may upload the details of the structured settlement 328 for sale which may include, but is not limited to the payout schedule, the insurance company, the term of sale and dates of cash flow payouts, the starting bid, the bid amount they will settle on immediately, the supporting documents with personal information redacted, the length of the auction, and any other suitable information (step 604). For example, the seller uploads supporting documents for a cash flow of $1,000 per month, 120 payments with an initial bid discount of 6% and thus a $90,724.32 asking sales price. The settle now price is 5% or $94,765.59. The system validates this information 330.

The buyer registers 302 and logs into 306 the password-protected buyer webpage portion of the site (step 606). They may choose to scroll through available cash flows, use the search function 308 or use the aggregate button (step 608). The aggregate button searches and gives the cumulative totals for multiple structured settlements that meet the buyer's needs. If the buyer, either directly or through their advisor, searches for all cash flows for, the $1000 per month for 120 months will be displayed as mentioned above. If the buyer is interested in that cash flow, he may place a bid 314 (step 610) at a discount rate of 6% or less or purchase the cash flow today at a 5% discount under the settle now choice. The auction and trading exchange server 316 automatically determines if the buyer is the winning bidder (step 612). Should the buyer choose to buy the cash flow under the settle now or win the auction with the best competitive bid, they will receive notification such as an email confirming their successful auction. A 5-10% deposit concurrent with a signed term sheet, for example, may be due immediately to secure the cash flow purchase (step 614). This may be done through the exchange in conjunction with the buyer's or originator's escrow account, or otherwise. Through the exchange, the buyer will receive the disclosure statement and after the applicable state's waiting period, contracting and documentation will begin. Upon the return of signed electronic contracts, preliminary checks and initial filings are performed. The automated exchange completes the transaction (step 616) and facilitates the entire process electronically.

The system may both provide automatic presentation of documents to both (or all) parties for finishing the transaction and contract and also collect electronic signatures from both (or all) parties for doing so. The funds may both be collected automatically from the buyer and transmitted to the seller automatically.

Some transactions on the exchange do not require an auction and may, for example, be a direct sale for a set price. The transactions and operations and interaction with the servers may be done with a smart phone application, tablet computer, personal computer, or any other suitable system. The operator of the system may receive an automated fee per transaction, subscription fees, or the spread between the selling discount rate and the buying discount rate. This fee may be automatically deducted and credited to the operator's account.

In another implementation, a buyer may submit requests for a desired cash flow. Buyers who do not see what they want can submit a request that automatically go out to registered originators electronically. This function allows advisors and different buyers to direct originators to look specifically for what they want. When an originator can find a match they can get to the end process much faster. This gives the buyer more options and the originators information for what is in the marketplace. Conventionally, the originators do not know what the marketplace will be when they originate a deal. This will help them in their pricing as well as give more inventory to the buyers whose demand outweighs the supply.

In yet another embodiment, the auction and trading system 316 allows buyers to view and customize their own compensation which will be imported directly into the court documents, for example, if the buyer is a financial advisor of a represented party. Money may be sent into an escrow account and then the auction and trading system may filter the appropriate money to the appropriate parties at closing. The compensation customization may allow buyers, such as financial advisors, to bid on cash flows while seeing their own compensation as an amount in net rate and net price. They may also see what the compensation percentage of net price will be. This may happen on one page where the buyer will see the bid and offer a bid on gross rate and the corresponding gross price. At this time, the buyer may bid to obtain the cash flow on the auction and trading system. Once the buyer has won the auction, the buyer may then be allowed to customize their own compensation on top of the already negotiated Gross Rate/Gross Price from the auction system. The auction system then gives the buyer the corresponding effective rate based on compensation to the buyer and the price to the buyer's client.

The foregoing description of embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements.

1. A method in a data processing system for auctioning and trading structured settlements, comprising:
receiving information from a buyer on a structured settlement to be sold;
transmitting an offer to sell the structured settlement;
receiving a bid from a buyer to buy the structured settlement;
automatically determining if the bid is the highest bid for the structured settlement;
automatically processing the receipt of funds from the buyer if the bid is the highest bid; and
automatically providing the received funds to the seller.

2. The method of claim 1 further comprising:
providing first documents to the buyer to complete a winning bid transaction;
receiving a first electronic signature from the buyer based on the provided first documents; and
providing second documents to the seller to complete the transaction; and
receiving a second electronic signature from the buyer based on the provided documents.

3. A method in a data processing system for auctioning and trading structured settlements, comprising:
receiving information from a buyer on a structured settlement to be sold including a set sale price;
transmitting an offer to sell the structured settlement;
receiving an offer to purchase the structure settlement at the set sale price from a buyer;
automatically processing the receipt of funds from the buyer based on the received offer; and
automatically providing the received funds to the seller.

4. The method of claim 3 further, comprising:
providing first documents to the buyer to complete a sale transaction;
receiving a first electronic signature from the buyer based on the provided first documents; and
providing second documents to the seller to complete the sale transaction; and
receiving a second electronic signature from the buyer based on the provided documents.

5. A data processing system for auctioning and trading structured settlements, comprising:
a memory configured to store instructions to cause a processor to:
receive information from a buyer on a structured settlement to be sold;
transmit an offer to sell the structured settlement;
receive a bid from a buyer to buy the structured settlement;
automatically determine if the bid is the highest bid for the structured settlement;
automatically process the receipt of funds from the buyer if the bid is the highest bid; and
automatically provide the received funds to the seller; and
the processor configured to execute the instructions.

6. The data processing system of claim 5, wherein the instructions further cause the processor to:
provide first documents to the buyer to complete a winning bid transaction;
receive a first electronic signature from the buyer based on the provided first documents; and
provide second documents to the seller to complete the transaction; and
receive a second electronic signature from the buyer based on the provided documents.
